(19) United States
(12) Patent Application Publication
(10) Pub. No.: US 2024/0343309 A1
(43) Pub. Date: Oct. 17, 2024

(54) LUGGAGE COMPARTMENT ASSEMBLY

(71) Applicant: BROSE FAHRZEUGTEILE SE & CO. KOMMANDITGESELLSCHAFT, COBURG, Coburg (DE)

(72) Inventors: Volker DEINHARD, Bamberg (DE); Hartmut BEYERSDORFER, Coburg (DE); Jan PEUKERT, Bamberg (DE); Kilian WIESMANN, Coburg (DE)

(21) Appl. No.: 18/294,046

(22) PCT Filed: Jul. 26, 2022
(86) PCT No.: PCT/EP2022/070857

§ 371 Date: Jan. 31, 2024

(30) Foreign Application Priority Data
Aug. 3, 2021 (DE) 10 2021 208 419.2

(51) Int. Cl. B62D 25/08; B60R 5/00

(52) U.S. Cl. CPC B62D 25/087; B60R 5/00

(57) ABSTRACT

It is provided a luggage compartment assembly for a luggage compartment of a vehicle, comprising at least one storage segment with a storage surface for the luggage compartment, which is adjustable relative to a base surface along an adjustment direction from a lowered position into at least one extended position. The luggage compartment assembly additionally comprises at least one wall adjustable along the adjustment direction, which laterally delimits a stowage space that is formed between the at least one storage segment present in the at least one extended position and a portion of the base surface.

### BACKGROUND

The proposed solution relates to a luggage compartment assembly for a luggage compartment of a vehicle according to the preamble of claim 1.

Such a luggage compartment assembly comprises at least one storage segment with a storage surface for the luggage compartment, which storage segment can be adjusted relative to a base surface along an adjustment direction from a lowered position into at least one extended position.

Such luggage compartment assemblies are known from the field of vehicle construction, in order to provide at least one height-adjustable storage surface in a luggage compartment of a vehicle.

DE 10 2016 120 503 A1 therefor discloses a storage system for the loading area of a vehicle comprising at least one floor-mounted storage compartment. The system furthermore contains at least one extendable shelf or compartment, which is designed to extend from the at least one storage compartment.

Items placed in the storage compartment or on the shelf can slip on the occurrence of forces, in particular forces transversely to a longitudinal vehicle axis. Such transverse forces can occur for example when driving through a bend. Slipping can lead both to a damage to the item and to an impairment of a rear view for a vehicle operator.

### SUMMARY

It is the object to improve a luggage compartment assembly with regard to the disadvantages in the prior art.

This object is achieved by a luggage compartment assembly with features as described herein.

Accordingly, the proposed luggage compartment assembly comprises at least one wall adjustable along the adjustment direction, which laterally delimits a stowage space that is formed between the at least one storage segment present in the at least one extended position and a portion of the base surface.

A lateral delimitation of the stowage space with the at least one wall can inhibit slipping of an object placed in the stowage space. This can reduce a damage to the object placed in the stowage space and/or a risk to the safety due to slipping of the object.

The shape of the stowage space is not restricted to a particular shape, in particular not to a cuboid. The stowage space can include a plurality of side surfaces. The side surfaces can be any not necessarily planar surfaces, which together with the portion of the base surface and the at least one storage segment delimit the stowage space.

For lateral delimitation of the stowage space the at least one wall can correspond to one of the side surfaces of the stowage space. An object placed in the stowage space accordingly can be impeded by the wall from leaving the stowage space through the side surface terminated by the wall.

In another embodiment the proposed luggage compartment assembly can include a plurality of walls. The walls can divide the stowage space into a number of stowage space portions. The stowage space thereby can be segmentable. This can improve the suitability for placing a plurality of items in the stowage space.

Each of the side surfaces of the stowage space can be terminated by a wall of the plurality of walls. Thus, it can be prevented that an object placed in the stowage space leaves the stowage space through one of the side surfaces. This can further reduce the risk of slipping of an object placed in the stowage space.

In the at least one extended position of the at least one storage segment, the at least one wall can be formed with a closed surface. This can prevent the slipping of small-scale objects placed in the stowage space.

The at least one wall formed with a closed surface in particular can fully extend over at least one of the side surfaces of the stowage space.

In an alternative configuration, the at least one wall can be formed with a perforated surface. By way of example, a perforated surface can be realizable by a mesh or grid. A mesh size of such a perforated surface can be designed corresponding to a usual object size. The mesh size in particular can be less than 5 cm, preferably less than 1 cm. The use of a perforated surface can reduce the material expenditure and the weight of the luggage compartment assembly.

In one configuration of the proposed luggage compartment assembly the at least one wall can be formed with a plurality of flat wall elements shiftable against each other in pairs along the adjustment direction. This can reduce the required installation space.

Each of the wall elements can be mounted on one of the remaining wall elements so as to be translationally adjustable. The plurality of such wall elements shiftably adjustable against each other can thus be telescopable along the adjustment direction between a retracted and an extended arrangement.

In another configuration of the proposed luggage compartment assembly, the at least one wall can be formed with an extractable woven tarpaulin. This can reduce a material expenditure.

The extractable woven tarpaulin can be formed with a rotatably mounted roller. The woven tarpaulin can be rollable onto the roller. The tarpaulin can be unrollable from the roller by rotating the roller in an unrolling direction. Conversely, the tarpaulin can be rollable onto the roller by rotating the roller along a roll-up direction.

In another configuration of the proposed luggage compartment assembly, the adjustment of the at least one wall along the adjustment direction can be coupled with the adjustment of the at least one storage segment along the adjustment direction. A comfort of use can be further increased thereby.

By way of example, an introduction of an adjusting force into the at least one storage segment can lead to an introduction of a further adjusting force into the at least one wall. The at least one storage segment and the at least one wall therefor can be coupled mechanically. By way of example, such a mechanical coupling can be realizable by a Bowden cable that connects the at least one storage segment to the at least one wall.

What is conceivable and possible, however, in principle are all couplings that are suitable to introduce the further adjusting force into the at least one wall in response to the introduction of the adjusting force into the at least one storage segment. The adjustment of the storage segment between the lowered position and the at least one extended position thus can effect the adjustment of the at least one wall.

What is likewise conceivable and possible are couplings that are suitable to introduce the adjusting force into the at least one storage segment in response to the introduction of the further adjusting force into the at least one wall. The adjustment of the storage segment between the lowered position and the at least one extended position thus can be effectable via the adjustment of the at least one wall.

In one configuration of the proposed luggage compartment assembly, the at least one storage segment can be adjusted into a plurality of extended positions. Each of the plurality of extended positions can differ with respect to a distance to the base surface. Thus, the at least one storage segment can be adjusted between a plurality of distances relative to the base surface. In particular, the distance to the base surface can be steplessly adjustable. This can increase a comfort of use of the storage surface of the at least one storage segment.

By way of example, one of the extended positions can be suitable to comfortably remove an item placed on the storage surface by a user of the luggage compartment. Due to the plurality of extended positions, the item can be comfortably removable independently of a size of the item.

In the luggage compartment assembly properly mounted in a luggage compartment of a vehicle, a center of gravity of the item placed on the storage surface can be shifted in the direction of a vehicle floor by adjusting one of the at least one extended positions into the lowered position. This can improve driving characteristics of the vehicle loaded with the item.

The at least one storage segment can be mounted on a guide connected to the luggage compartment assembly. By way of example, such a guide can be realizable with a rail guide.

The at least one wall can be mounted on a further guide connected to the luggage compartment assembly.

In one configuration of the proposed luggage compartment assembly, the at least one wall and the at least one storage segment can be guided along a common guide. By way of example, the at least one wall and the at least one storage segment can be guided on a common rail.

In another embodiment of the proposed luggage compartment assembly, the at least one storage segment and the at least one wall can be connected to each other. A guide of the at least one wall or the at least one storage segment thereby can be omitted.

By way of example, the at least one wall can be adjustably guided on a guide along the adjustment direction. The storage segment connected to the at least one wall can be indirectly guided via the wall.

Analogously, it is conceivable and possible that the storage segment is adjustably guided on a guide along the adjustment direction. The at least one wall can be indirectly guided via the connection to the at least one storage segment.

Due to a connection of the at least one storage segment with the at least one wall, the at least one storage segment and the at least one wall can be adjustable when coupled with each other.

In another configuration of the proposed luggage compartment assembly, the at least one storage segment can be adjustable along the adjustment direction between a plurality of planes parallel to each other. This can further improve the suitability of the storage surface for placing items.

In particular, the luggage compartment assembly in the state properly mounted in a vehicle can be arranged in such a way that the planes are horizontal.

In another configuration of the proposed luggage compartment assembly, the luggage compartment assembly can include at least one electronically controllable drive for the power-operated adjustment of the at least one storage segment. The comfort of use can be increased thereby.

Such a drive can be adapted to receive a control signal and to adjust the at least one storage segment along the adjustment direction in response to a control signal.

The control signal can include information on a target position into which the at least one storage segment is to be adjusted via the at least one drive. Alternatively, the control signal can be of the binary type. A binary control signal can have a forward and a rearward value. The at least one drive can be adapted to adjust the at least one storage segment along the adjustment direction or against the adjustment direction in dependence on the receipt of the forward or rearward value.

The luggage compartment assembly can include a control unit that is coupled with the at least one drive. The control unit can be adapted to send the control signal to the drive.

By way of example, the at least one drive of the proposed luggage compartment assembly can be formed with a spindle drive. Furthermore by way of example, the at least one drive can be formed with a Bowden cable, a direct drive on a guide rail, or a gearwheel drive.

In another configuration of the proposed luggage compartment assembly, the same can be adapted to adjust the at least one storage segment via the at least one drive in response to an operating event. A comfort of use can be further improved thereby.

By way of example, the control unit can be adapted to send the control signal to the at least one drive in response to an operating event. This can reduce the expenditure for the adjustment of the at least one storage segment for a user.

In particular, the control unit can be adapted to adjust the at least one storage segment into a predetermined position in dependence on the operating event. By way of example, the control unit therefor can be adapted to send a control signal with the target position corresponding to the predetermined position to the at least one drive. Furthermore by way of example, the control unit can be adapted to send a control signal with a forward or rearward value to the at least one drive, until the predetermined position is reached.

By way of example, the luggage compartment assembly can include a memory element coupled with the control unit, on which the predetermined position of the at least one storage segment each is stored for a plurality of possible operating events.

In one configuration of the proposed luggage compartment assembly, the luggage compartment assembly can be adapted to recognize at least one of the following events as an operating event:
actuating a trigger device,
detection of an object in a predetermined detection area, or
recognizing a predetermined object in a predetermined recognition area.

Thereby, the expenditure for the adjustment of the at least one storage segment can be reduced and/or the adjustment can be automatable.

In an exemplary configuration of the proposed luggage compartment assembly, the luggage compartment assembly can include at least one event sensor for recognizing the operating event. The adjustment of the at least one storage segment thereby can be effected in particular in an automated way.

In principle, the at least one event sensor can be any kind of device that is adapted to detect a predetermined event and send a detection signal to a control unit coupled with the event sensor. In response to the receipt of the detection signal, the control unit can send the control signal to the at least one drive in order to adjust the at least one storage segment.

By way of example, the at least one event sensor can be formed with a switch or touch sensor. The event sensor can be adapted to send the detection signal to the control unit in response to a manual actuation.

In another configuration, the at least one event sensor can be formed with a RADAR device, a LIDAR device or a similar detection means, in order to detect the presence of a person in a predetermined detection space and to send the detection signal to the control unit in response to the detection of a person.

In another exemplary configuration, the at least one event sensor can be formed with a radio sensor, such as an RFID, NFC or Bluetooth sensor, in order to recognize a particular person or a particular object. This can provide for an object- and/or person-related adjustment of the storage segment.

In particular, the recognition of a predetermined suitcase can be realizable thereby. In response to the recognition of a predetermined person or a predetermined object, the detection signal can be sent to the control unit. The control unit can be adapted to adjust the at least one storage segment into a predetermined position in dependence on the detection signal. The predetermined position can be taken from the memory element in dependence on a size of the recognized suitcase. Furthermore, the control unit can be adapted to adjust the at least one storage segment into the lowered position in response to the recognition that an object has been placed in the luggage compartment assembly.

In another exemplary configuration, the control unit can be adapted to receive the target position into which the at least one storage segment is to be adjusted. By way of example, the control unit therefor can include a radio module. The radio module can be adapted to receive data e.g. via a mobile radio network, Bluetooth, WLAN or NFC from a correspondingly configured device, such as a mobile phone.

In one configuration of the proposed luggage compartment assembly, the control unit can be adapted to predict a position of the at least one storage segment desired by a luggage compartment user by means of a logic in response to the receipt of the detection signal and to adjust the at least one storage segment into the desired position by sending the control signal.

In another configuration of the proposed luggage compartment assembly, the same can include at least one securing element for securing an object placed on the at least one storage segment. A load securement can be improved thereby.

By way of example, the securing element can be formed with a securing strap or a securing net. In particular, the securing element can be releasably fixable to the luggage compartment assembly with at least one end portion.

In one configuration of the proposed solution, the at least one securing element can be constructionally separated from the remaining elements of the luggage compartment assembly. In the properly mounted state of the luggage compartment assembly, the at least one securing element can be arranged in the luggage compartment in such a way that a securement of objects placed on the at least one storage segment is possible.

In another configuration of the proposed luggage compartment assembly, the luggage compartment assembly can include an electronically controllable adjusting device for adjusting a length of the at least one securing element. This can improve the load securement by the at least one securing element.

In one embodiment, the adjusting device can be adapted to perform a length adaptation of the securing element in a power-operated way. In an additional or alternative embodiment, the adjusting device can be adapted to block the length adaptation by an externally introduced force. For electronic control, the adjusting device can coupled with the control unit and be adapted to receive a signal for length adjustment or for blocking the length adjustment. The adjusting device furthermore can be adapted to perform or block the length adjustment of the at least one securing element in response to the receipt of the signal. This can in particular increase the operating comfort.

In another configuration of the proposed solution, the luggage compartment assembly can be adapted to control the length adjustment of the at least one securing element in dependence on a pressure applied onto the at least one storage segment. This can improve a load securement.

The pressure applied onto the at least one storage segment can be effectable by the at least one securing element. The pressure applied onto the at least one storage segment can also be effected by an object placed on the at least one storage segment and secured by the at least one securing element. By way of example, a force acting in the direction of the storage segment can be applied onto the object by the at least one securing element.

In an alternative or additional configuration, the luggage compartment assembly can be adapted to control the adjusting device in dependence on a tensile force introduced into the at least one securing element. This can improve a load securement.

In one configuration, the luggage compartment assembly can be adapted to block the length adjustment of the at least one securing element and to adjust the at least one storage segment until the pressure applied onto the at least one storage segment lies within a predetermined target range.

In an alternative or additional configuration, the luggage compartment assembly can be adapted to adapt the length of the at least one securing element. In the process, the at least one storage segment can be fixed with respect to the position. Thus, due to the electronically controllable adjustment of the length of the at least one securing element, the pressure applied onto the at least one storage segment can be adjustable.

According to another alternative or additional configuration, the luggage compartment assembly can be adapted to adjust both the length of the at least one securing element and the position of the at least one storage segment.

As an alternative to the pressure applied onto the at least one storage segment, the tensile force introduced into the at least one securing element can also be used as a target quantity with a predetermined target range.

In one configuration of the proposed luggage compartment assembly, the luggage compartment assembly can include at least one force sensor for determining the tensile force introduced into the at least one securing element. This can improve an automation of the luggage compartment assembly.

The at least one force sensor can be coupled with the control unit and be adapted to determine the tensile force introduced into the at least one securing element and send it to the control unit as an output value.

According to another configuration of the proposed solution, the luggage compartment assembly can include at least one pressure sensor for determining the pressure applied onto the at least one storage segment. This can further improve an automation of the luggage compartment assembly.

The at least one pressure sensor can be coupled with the control unit and be adapted to determine the pressure applied onto the at least one storage segment and send it to the control unit as an output value.

In another configuration of the proposed solution, the at least one storage segment can include an opening in order to provide for an access to the at least one stowage space of the at least one storage segment. This can improve the comfort of use.

In particular, the opening can be designed to be closable. By way of example, a flap therefor can be arranged on the at least one storage segment.

In another configuration of the proposed solution, the luggage compartment assembly can include a substantially flat base element connected to the at least one storage segment. The luggage compartment assembly thereby can be premountable outside a luggage compartment provided for proper mounting.

In one configuration, the at least one wall can be connected to the base element.

The base surface can correspond to a surface of the base element facing the at least one storage segment. By way of example, the wall can be retractable into the base element. In one embodiment, the base element therefor can include at least one opening.

The base element can include elevations and depressions. In particular, the base element can include depressions into which the at least one storage segment is at least partly retractable in the lowered position. This can increase a maximally available stowage space.

In another configuration of the proposed luggage compartment assembly, the luggage compartment assembly can include a plurality of height-adjustable storage segments. This can improve an adaptation of the luggage compartment assembly to various situations of use.

Accordingly, the proposed luggage compartment assembly can include a plurality of storage segments adjustable relative to the base surface along the adjustment direction from the lowered position into the at least one extended position, which each comprise a storage surface for the luggage compartment. Each of the storage segments defines a stowage space each in the at least one extended position and a portion of the base surface.

Each of the storage segments of the plurality of adjustable storage segments can correspond to one of the proposed embodiments.

In another configuration of the proposed solution, the luggage compartment assembly can be adapted to adjust each storage segment of the plurality of storage segments independently of the remaining ones of the plurality of storage segments along the adjustment direction. This can further improve the comfort of use.

Each of the storage segments of the plurality of storage segments can include an electronically controllable drive for adjusting the respective storage segment along the adjustment direction. Each of the drives can introduce an adjusting force into each of the plurality of storage segments independently of the remaining drives. Each of the drives can be coupled with the control unit and be adapted to receive a control signal determined for the respective drive from the control unit. The drives can be adapted to adjust the respective storage segment along the adjustment direction in response to the receipt of the respective control signal.

In one configuration of the proposed luggage compartment assembly, at least two storage segments can define a common storage surface in an identical position relative to the base surface. The luggage compartment assembly can be adapted to provide at least one common storage surface by an adjustment of the plurality of storage segments. This can provide for an adaptation of the luggage compartment to items of different dimensions.

In one configuration of the proposed luggage compartment assembly, the luggage compartment assembly can be adapted to adjust all storage surfaces into an extended position maximally spaced from the base surface in response to the operating event. This can facilitate loading of the luggage compartment.

In another configuration, the luggage compartment assembly can be adapted to provide a common storage surface adapted to an object. By way of example, a particular object can be recognized by means of a detection sensor and a storage surface can be provided corresponding to the dimensions stored for the predetermined object.

In another configuration of the proposed solution, each of the plurality of storage segments can be individually adjusted along the adjustment direction corresponding to an adjustment request of a user. This can provide for an adaptation of the luggage compartment to individual items.

The object mentioned above also is achieved by a vehicle with a luggage compartment and a luggage compartment assembly mounted in the luggage compartment according to one of the preceding embodiments.

By way of example, the control unit of the luggage compartment assembly can be coupled with an on-board electronic system of the vehicle. In particular, the luggage compartment assembly can thus be operable via an on-board computer of the vehicle.

In another configuration of the proposed vehicle, the vehicle can be a purely electrically driven vehicle.

In another configuration of the proposed vehicle, the luggage compartment can be arranged in the region of the front of the vehicle. In addition, the vehicle can include a further luggage compartment in the region of the rear of the vehicle. Alternatively, the vehicle can include the luggage compartment in the region of the rear of the vehicle, without having any further luggage compartment. In principle, the luggage compartment or the further luggage compartment can also include a luggage compartment assembly in the region of the rear of the vehicle.

According to another configuration of the proposed solution, the vehicle includes an adjustable luggage compartment cover and a coupling device for coupling an adjustment of the luggage compartment cover with the adjustment of the at least one storage segment. This can further increase the comfort of use.

By way of example, the proposed vehicle can be adapted to adjust the at least one storage segment into an extended position in response to an opening of the luggage compartment cover. In particular, the vehicle can be adapted to adjust the at least one storage segment into an extended position maximally spaced with respect to the base surface in response to an opening of the luggage compartment cover. This can simplify the loading of the luggage compartment.

In another configuration of the proposed solution, the vehicle can be adapted to perform a detection attempt according to a number of predetermined objects in response to the opening of the luggage compartment cover. In particular, the vehicle can be adapted to search for a number of radio signals stored in the memory. Such radio signals by way of example can be sent by RFID transmitters, NFC transmitters or Bluetooth devices. Each of the radio signals stored in the memory can be connected with a number of dimensions of associated objects stored in the memory. The vehicle can be adapted to adjust the at least one storage segment in response to the detection of one of the radio signals stored in the memory based on the dimensions stored in the memory. By way of example, a common storage surface can be provided by at least two storage segments in response to the detection of one of the radio signals belonging to a suitcase, which corresponds to a width of the detected suitcase.

The preceding explanations on the embodiments and advantages of the luggage compartment assembly are also applicable analogously to the proposed vehicle.

### BRIEF DESCRIPTION OF THE DRAWINGS

The attached Figures by way of example illustrate possible design variants of the proposed solution.

FIG. 1A shows a perspective representation of a first design variant of the proposed luggage compartment assembly comprising a base surface, two walls and an adjustable storage segment in a lowered position.

FIG. 1B shows the embodiment represented in FIG. 1A in an extended position of the storage segment.

FIGS. 2-4 show perspective representations of another embodiment of the proposed luggage compartment assembly with three adjustable storage segments in various positions.

FIG. 5 shows another embodiment of the proposed luggage compartment assembly with three storage segments and two securing elements.

FIG. 6 shows another embodiment of the proposed luggage compartment assembly with three storage segments each adjustable via two spindle drives.

FIGS. 7-10 show perspective representations of a first embodiment of a proposed vehicle with an embodiment of the proposed luggage compartment assembly with three adjustable storage segments in various positions.

### DETAILED DESCRIPTION

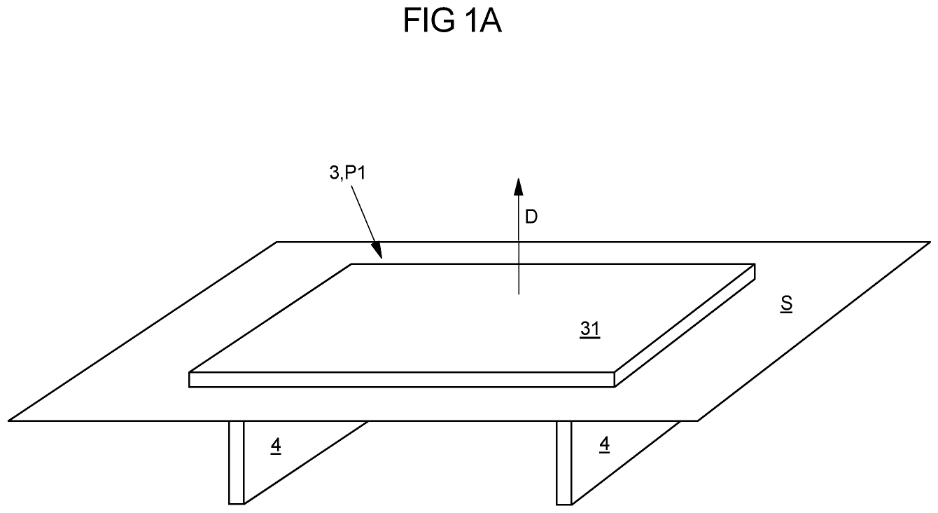

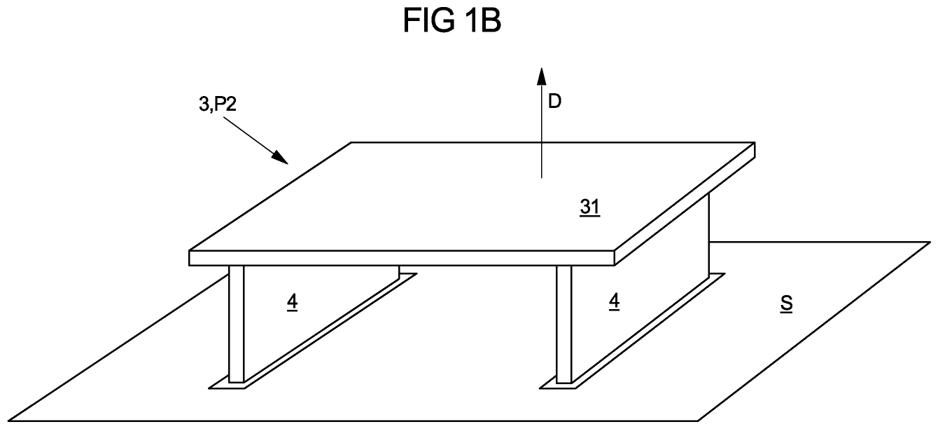

FIG. 1 shows a luggage compartment assembly 1 for a luggage compartment 81 of a vehicle 8 comprising a storage segment 3 with a storage surface 31 for the luggage compartment 81. The storage segment 3 is adjustable relative to a base surface S along an adjustment direction D from an illustrated lowered position P1 into at least one extended position P2, P2′. Two flat walls 4 are arranged on the storage segment 3. The walls 4 are spaced relative to each other and arranged on the storage segment 3 orthogonally to the same. Both walls 4 extend through non-illustrated openings in the base surface S. In the lowered position P1 shown in FIG. 1A, the storage segment 3 flatly rests on the base surface S.

By shifting the storage segment 3 along the adjustment direction D into one of the extended positions P2, P2′, the storage segment 3 and the base surface S define an interposed stowage space. The stowage space is delimited by the two walls 4 on two side surfaces of the stowage space.

FIG. 1B shows the embodiment of the proposed luggage compartment assembly 1 of FIG. 1A in the extended position P2. As compared to FIG. 1A, the storage segment 3 is shifted relative to the base surface S along the adjustment direction D. Between the storage segment 3 and the base surface S the stowage space is located, which on two sides is delimited by the walls 4. The walls 4 each extend through an opening in the base surface S formed as an oblong hole.

In a configuration of the proposed solution deviating from the illustrated embodiment, the luggage compartment assembly 1 in principle can also have more than one storage segment 3. Each of the plurality of storage segments 3 can have one or more walls, which on at least one side delimit the stowage space each formed between one of the storage segments 3 and a portion of the base surface S.

In alternative embodiments, one or more walls 4 furthermore cannot be connected to the storage segment 3. In addition, the walls 4 in principle can be designed in every shape that is suitable for laterally delimiting the stowage space formed between the storage segment 3 and a portion of the base surface S. In embodiments deviating from the illustrated flat configuration, the wall 4 or the walls 4 by way of example can be formed with a woven tarpaulin, a grid, a mesh or a telescopable wall 4.

In further alternative embodiments, the base surface S in configurations deviating from the illustrated embodiment can include depressions 21 and/or elevations. In particular, the storage segments 3 and the base surface S can have base surfaces different from a rectangle.

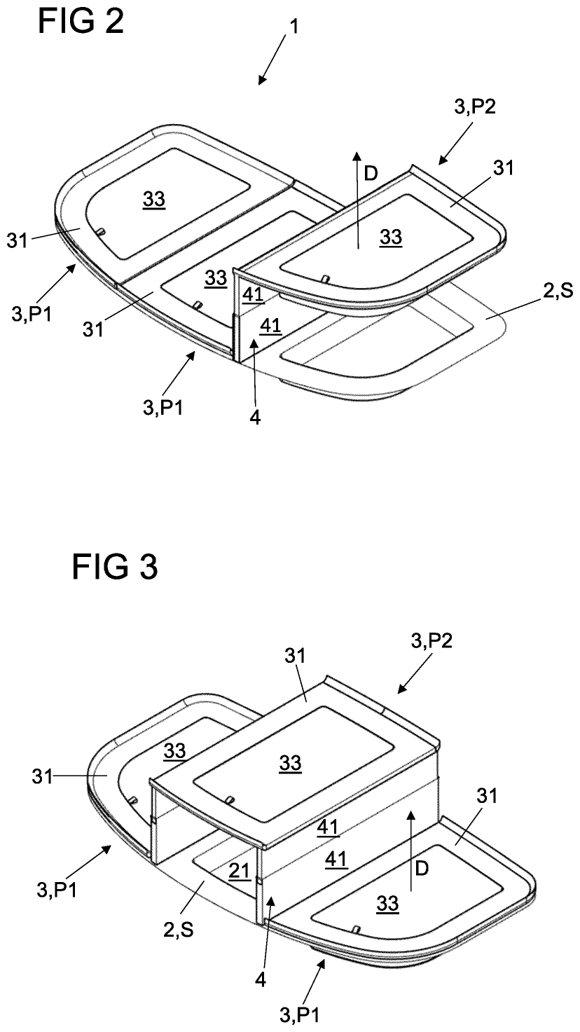

FIGS. 2, 3 and 4 show perspective representations of another embodiment of the illustrated luggage compartment assembly 1. The embodiment includes three storage segments 3 adjustable along the adjustment direction D and arranged in a row. On a side facing an adjacent storage segment 3 each of the three storage segments 3 is each connected to a telescopable wall 4. The telescopable wall 4 includes two wall elements 41, which are mounted at each other so as to be translationally shiftable against each other along the adjustment direction D. Each of the walls 4 is arranged on the base element 2. With a surface facing the storage segments 3, the base element 2 defines the base surface S. Furthermore, the base element 2 includes three depressions 21 that are adapted to each receive one of the storage segments 3 at least partly in the lowered position P1. In the at least one extended position P2, P2′, each of the storage segments 3 together with a portion of the base surface S each defines a stowage space that is laterally delimited by at least one of the walls 4. Each of the storage segments 3 furthermore includes an opening 32 closed with a flap 33, which provides access to the respective stowage space.

FIG. 2 shows two adjacent storage segments 3 in the lowered position P1. The two adjacent storage segments 3 thus define a common storage surface 31 at the height of the lowered position P1. On the other hand, the third storage segment 3 is adjusted into the extended position P2 along the adjustment direction D. The wall 4 connected to the storage segment 3 in the extended position P2 laterally delimits the common storage surface 31 formed by the two remaining storage segments 3. In the arrangement of the three storage segments 3 shown in FIG. 2, exactly one stowage space accordingly is provided. The same is defined by the one extended storage segment 3 and a portion of the base surface S.

In contrast to FIG. 2, FIG. 3 shows an arrangement of the same embodiment of the proposed luggage compartment assembly 1, in which none of the adjacent storage segments 3 is adjusted into the same position P1, P2. Both of the outer storage segments 3 are present in the lowered position P1. The remaining storage segment 3 enclosed by the two storage segments 3 in the lowered position P1, on the other hand, is adjusted into the extended position P2 along the adjustment direction D. The arrangement shown in FIG. 3 thus provides exactly one stowage space. The exactly one stowage space is provided between the storage segment 3 adjusted into the extended position P2 and a portion of the base surface S.

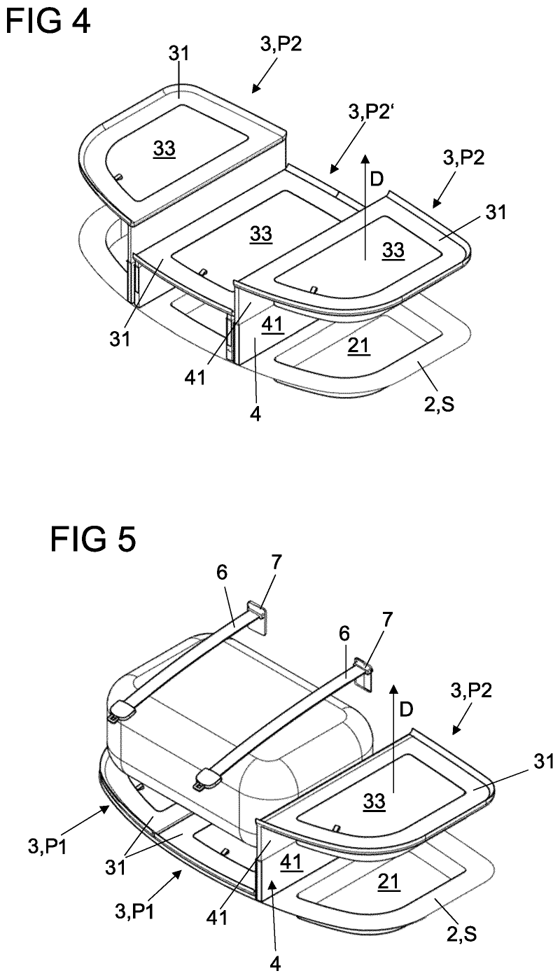

In contrast to the arrangements of the proposed luggage compartment assembly shown in FIGS. 2 and 3, FIG. 4 shows an arrangement in which all three storage segments 3 are adjusted into one of the extended positions P2, P2′. Adjacent storage segments 3 each have different positions P2, P2′. The two outer storage segments 3 each are adjusted into the extended position P2, whose spacing with respect to the base surface S is greater than the further extended position P2′ of the middle storage segment 3. The arrangement of the three storage segments 3 shown in FIG. 4 thus provides three stowage spaces. The stowage spaces provided by the two outer storage segments 3 with one portion each of the base surface S are identical in terms of the volume.

FIG. 5 shows another embodiment of the proposed luggage compartment assembly 1 with three storage segments 3 corresponding to the arrangement shown in FIG. 2. In contrast to FIG. 2, the embodiment of the luggage compartment assembly 1 shown in FIG. 5 includes two securing elements 6. The securing elements 6 are configured with length-adjustable straps that can releasably be fixed to non-illustrated locks of the luggage compartment assembly 1.

Furthermore, FIG. 5 shows an object in the form of a suitcase placed on the common storage surface 31 in the lowered position P1. Said suitcase is secured against a movement along the adjustment direction D by the two securing elements 6. In the properly mounted state of the luggage compartment assembly 1, the adjustment direction D in particular can correspond to the vertical direction.

By way of example, a pressure applied by the item onto the common storage surface 31 can be increased by fixing the securing elements 6 to the locks when a longitudinal adjustment is blocked by an adjustment of the common storage surface 31 along the adjustment direction D. Alternatively, securing elements 6 can be releasably fixed to the non-illustrated locks and a length of the securing elements 6 can be adapted via an electronically controllable adjusting device 7.

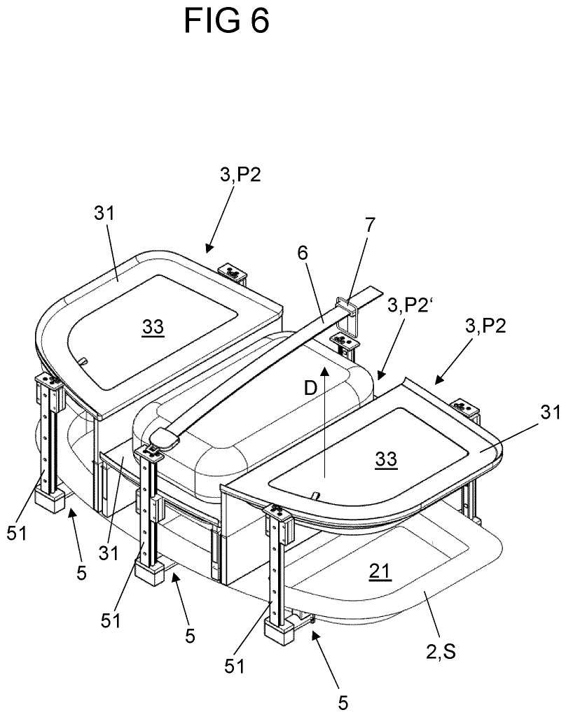

FIG. 6 shows another embodiment of the proposed luggage compartment assembly 1 with three storage segments 3 corresponding to the arrangement shown in FIG. 4. Each of the storage segments 3 is connected to the base element 2 on two opposite sides via a drive 5 formed with a spindle drive. In addition, a securing element 6 is arranged above the middle storage segment 3 along the adjustment direction D. The observations concerning an adaptation of the pressure by adjusting the storage segment 3 or the length of the securing element 6 apply analogously to the observations on FIG. 5.

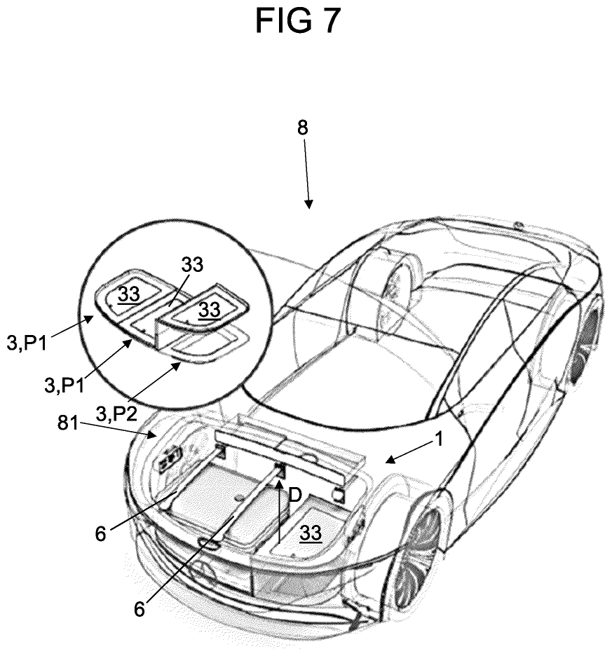

FIG. 7 shows an embodiment of the vehicle 8 of the proposed solution. In the region of the front of the vehicle 8 a luggage compartment 81 is arranged, in which an embodiment of the proposed luggage compartment assembly 1 with three storage segments 3 is mounted. The arrangement of the storage segments 3 corresponds to the arrangement shown in FIGS. 2 and 5. Like in FIG. 5, an object in the form of a suitcase is placed on the common storage surface 31 formed by the two adjacent storage segments 3 arranged in the lowered position P1. Said suitcase is secured against the movement along the adjustment direction D or the vertical direction by the two securing elements 6.

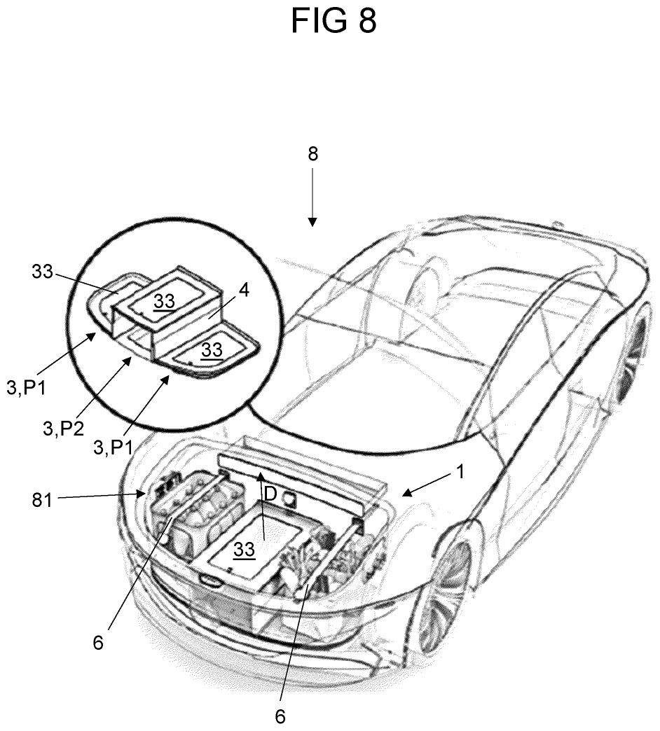

In an arrangement of the storage segments 3 different from the arrangement shown in FIG. 7, FIG. 8 shows the luggage compartment assembly 1 in the arrangement of FIG. 3. On the two storage surfaces 31 arranged in the lowered position P1 there are each placed objects that are secured against the movement along the adjustment direction D or the vertical direction by means of one securing element 6 each. The middle storage segment 3 defines the stowage space accessible via the flap 33.

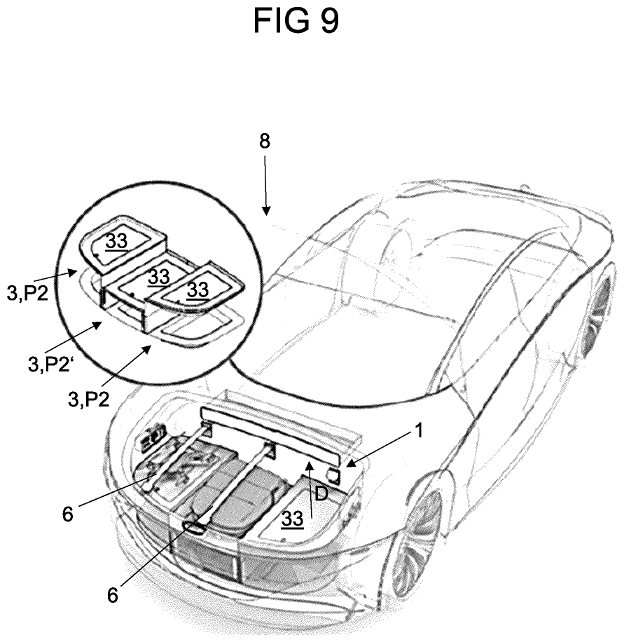

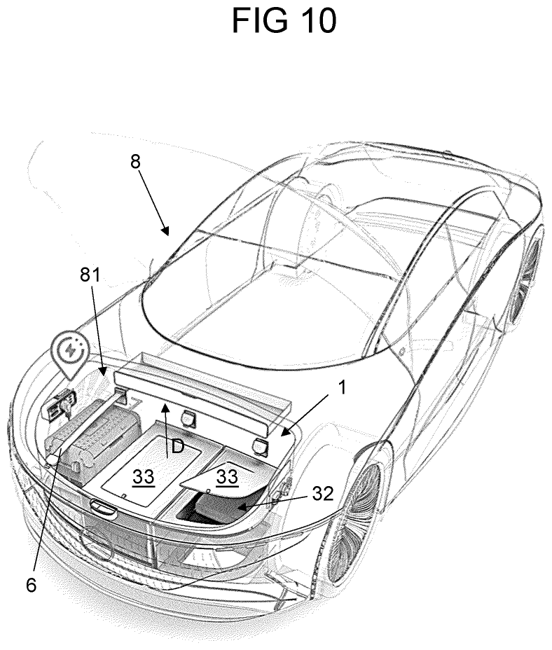

FIG. 9 shows the vehicle 8 with the luggage compartment assembly 1 in the arrangement shown in FIGS. 4 and 6. On the middle storage segment 3, whose further extended position P2′ has a smaller spacing with respect to the base element 2 than the two lateral storage segments 3, an object is placed and secured against the movement along the adjustment direction D or the vertical direction by means of the securing element 6. An expansion of the item along the adjustment direction D corresponds to the difference between the spacing of the middle storage segment 3 relative to the base element 2 and the spacing of the outer storage segments 3 relative to the base element 2. The storage surfaces 31 of the outer storage segments 3 and an upper side of the item thus substantially form a common plane.

FIG. 10 shows a further arrangement of the luggage compartment assembly 1 of the vehicle 8. Two adjacent storage segments 3 are adjusted into the extended position P2 and thus define a common storage surface 31 in the extended position P2. Each of the storage segments 3 in the extended position P2 thus provides a stowage space that is accessible via a flap 33. The third storage segment 3 is arranged in the lowered position P1. In the lowered position P1 a freezer is placed on the storage surface 31, which is secured against the movement along the adjustment direction D or the vertical direction by means of a securing element 6. The freezer is connected to an on-board network of the vehicle 8 via a terminal for supply with electric energy.

In configurations deviating from the illustrated embodiments, the vehicle 8 in principle also can include a luggage compartment assembly 1 of the proposed type in a luggage compartment 81 in the rear region. The luggage compartment assembly 1 according to the proposed solution is not limited in terms of the number of storage segments 3, the walls 4, the configuration of the storage surface 31 with or without opening 32, the number and configuration of the securing elements 6, and the configuration of the base element 2.

### LIST OF REFERENCE NUMERALS

1 luggage compartment assembly
2 base element
21 depression
D adjustment direction
S base surface
3 storage segment
31 storage surface
32 opening
33 flap
P1 lowered position
P2, P2′ extended position
4 wall
41 wall element
5 drive
51 spindle drive
6 securing element
7 adjusting device
8 vehicle
81 luggage compartment

1. A luggage compartment assembly for a luggage compartment of a vehicle, comprising at least one storage segment with a storage surface for the luggage compartment, which is adjustable relative to a base surface along an adjustment direction from a lowered position into at least one extended position,
wherein the luggage compartment assembly additionally comprises at least one wall adjustable along the adjustment direction, which laterally delimits a stowage space that is formed between the at least one storage segment present in the at least one extended position and a portion of the base surface.

2. The luggage compartment assembly according to claim 1, wherein in the at least one extended position of the at least one storage segment the at least one wall is formed with a closed surface.

3. The luggage compartment assembly according to claim 1, wherein the at least one wall is formed with a plurality of flat wall elements shiftable against each other in pairs along the adjustment direction.

4. The luggage compartment assembly according to claim 1, wherein the at least one wall is formed with an extractable woven tarpaulin.

5. The luggage compartment assembly according to claim 1, wherein an adjustment of the at least one wall along the adjustment direction is coupled with an adjustment of the at least one storage segment along the adjustment direction.

6. The luggage compartment assembly according to claim 1, wherein the luggage compartment assembly, for the power-operated adjustment of the at least one storage segment, includes at least one electronically controllable drive.

7. The luggage compartment assembly according to claim 6, wherein the luggage compartment assembly is adapted to adjust the at least one storage segment via the at least one drive in response to an operating event.

8. The luggage compartment assembly according to claim 7, wherein the luggage compartment assembly is adapted to recognize at least one of the following events as an operating event:
actuating a trigger device,
detection of an object in a predetermined detection area, or
recognizing a predetermined object in a predetermined recognition area.

9. The luggage compartment assembly according to claim 1, wherein the luggage compartment assembly includes at least one securing element, for securing an object lying on the at least one storage segment.

10. The luggage compartment assembly according to claim 9, wherein the luggage compartment assembly includes an electronically controllable adjusting device for adjusting a length of the at least one securing element.

11. The luggage compartment assembly according to claim 10, wherein the luggage compartment assembly is adapted to control the adjusting device of the at least one securing element in dependence on a pressure applied onto the at least one storage segment by action of the at least one securing element or a tensile force introduced into the at least one securing element.

12. The luggage compartment assembly according to claim 1, wherein the at least one storage segment includes an opening in order to provide for access to the at least one stowage space of the at least one storage segment.

13. The luggage compartment assembly according to claim 1, wherein the luggage compartment assembly includes a substantially flat base element connected to the at least one storage segment.

14. The luggage compartment assembly according to claim 1, wherein the luggage compartment assembly includes a plurality of height-adjustable storage segments.

15. The luggage compartment assembly according to claim 14, wherein the luggage compartment assembly is adapted to adjust each storage segment of the plurality of storage segments independently of the remaining ones of the plurality of storage segments along the adjustment direction.

16. A vehicle including a luggage compartment and a luggage compartment assembly mounted in the luggage compartment according to claim 1.

17. The vehicle according to claim 16, wherein the luggage compartment is arranged in the region of the front of the vehicle.
